(19) United States
(12) Patent Application Publication
(10) Pub. No.: US 2022/0239809 A1
(43) Pub. Date: Jul. 28, 2022

(54) POLYMERIZABLE COMPOSITION, OPTICAL ELEMENT AND METHOD FOR PRODUCING THE SAME, OPTICAL DEVICE, AND IMAGE CAPTURING APPARATUS

(71) Applicant: CANON KABUSHIKI KAISHA, Tokyo (JP)

(72) Inventor: Yuuta Tsuruki, Kanagawa (JP)

(21) Appl. No.: 17/581,721

(22) Filed: Jan. 21, 2022

(30) Foreign Application Priority Data
Jan. 28, 2021 (JP) 2021-011604

(51) Int. Cl. H04N 5/225; C08G 63/66; G02B 1/04

(52) U.S. Cl. CPC H04N 5/2254; C08G 63/66; G02B 7/021; H04N 5/2252; G02B 1/041

(57) ABSTRACT

A resin layer is formed by filling a polymerizable composition between a substrate and a mold and polymerizing and curing the composition, wherein the polymerizable composition comprises a fluorene compound and a thiol compound comprising 2 to 4 thiol groups, a ratio of the number of sulfur atoms the thiol compound to the number of polymerizable functional groups of the fluorene compound is 0.02 or more and 0.25 or less.

### BACKGROUND OF THE INVENTION

### Field of the Invention

The present disclosure relates to an optical element used in an image capturing apparatus or an optical device, a method of producing the optical element, and a polymerizable composition used in the manufacturing method.

### Description of the Related Art

As one of the optical elements, an optical lens in which a resin layer is formed on a surface of a glass lens serving as a base material is known. The optical lens having such a resin layer is formed by using a mold. That is, a resin layer having a desired shape can be formed on the surface of the base material by injecting the polymerizable composition between the base material and the mold and curing it. The optical lens produced by such a manufacturing method is called a replica element. Since a desired surface shape can be easily formed by this method, the replica element is effective for use as an aspherical lens or a Fresnel lens. The aspherical lens is a general term for a lens whose curvature continuously changes from the center to the periphery of the lens.

Japanese Patent Application Laid-Open No. 2002-228805 discloses, as one of the replica elements, an aspherical lens in which a crack in a base material during mold release is suppressed by specifying a film thickness and a material of a resin layer formed on the substrate.

### SUMMARY OF THE INVENTION

The present disclosure provides an optical element comprising a substrate and a resin layer on said substrate, wherein the resin layer comprises a polymerization product of a polymerizable composition comprising a fluorene compound represented by formula (1) and at least one of a thiol compound represented by formula (2) and an oligomer of the thiol compound wherein a ratio of the number of sulfur atoms in said at least one of a thiol compound and an oligomer of the thiol compound to the number of polymerizable functional groups in said fluorene compound is 0.02 or more and 0.25 or less.

Formula (1) is represented by

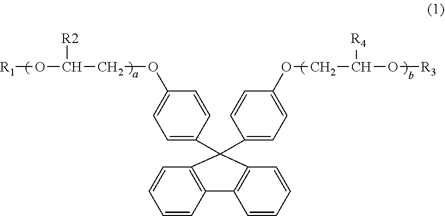

where R₁ and R₃ are each independently a polymerizable functional group represented by any one of formulas (a) to (e), R₂ and R₄ are each independently a hydrogen atom or a methyl group, and a and b are each independently an integer of 1 to 4,

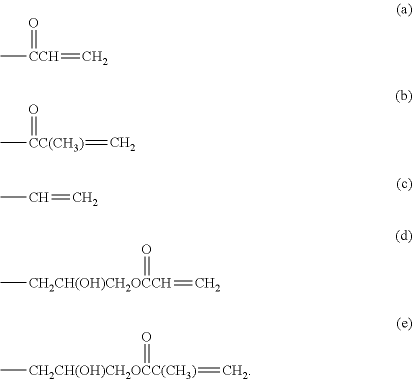

Formula (2) is represented by

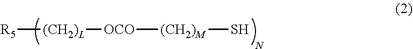

where R₅ is an N-valent hydrocarbon having 1 to 3 carbon atoms, L is an integer of 0 to 2, M is an integer of 1 or 2, and N is an integer of 2 to 4.

Further features of the present disclosure will become apparent from the following description of exemplary embodiments with reference to the attached drawings.

### BRIEF DESCRIPTION OF THE DRAWINGS

FIG. 1 is a schematic sectional view of an optical element according to an embodiment of the present disclosure.

FIGS. 2A and 2B are cross-sectional schematic views showing a molding process of a resin layer of the optical element of the embodiment of FIG. 1.

FIG. 3 is a schematic diagram showing a configuration of one embodiment of an image capturing apparatus according to the present disclosure.

FIG. 4 is a schematic sectional view showing the film thickness of the resin layer of the optical element of the embodiment of FIG. 1.

### DESCRIPTION OF THE EMBODIMENTS

In Japanese Patent Application Laid-Open No. 2002-228805, the water absorption expansion rate of the resin used is high, and the formed resin layer expands and shrinks when the humidity in the operating environment changes. In this case, since the thickness of the resin in the aspherical lens is different depending on the in-plane film thickness distribution, the amount of water absorption expansion and shrinkage is different, the amount of deformation in the plane is varied, and the surface shape of the resin is deformed from the initial stage. As a result, there has been a disadvantage that the optical performance of the replica element is changed and the image quality obtained when the replica element is used for the optical system is lowered. An embodiment of the present disclosure will be described below with reference to the drawings.

(Optical Element)

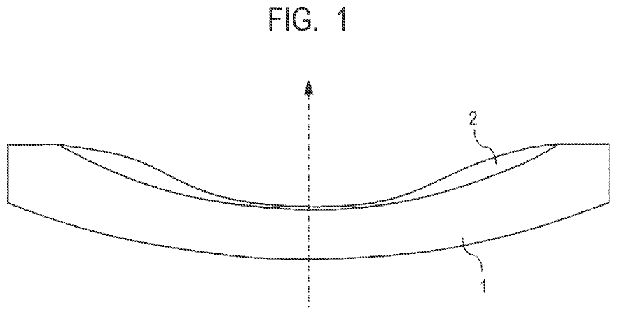

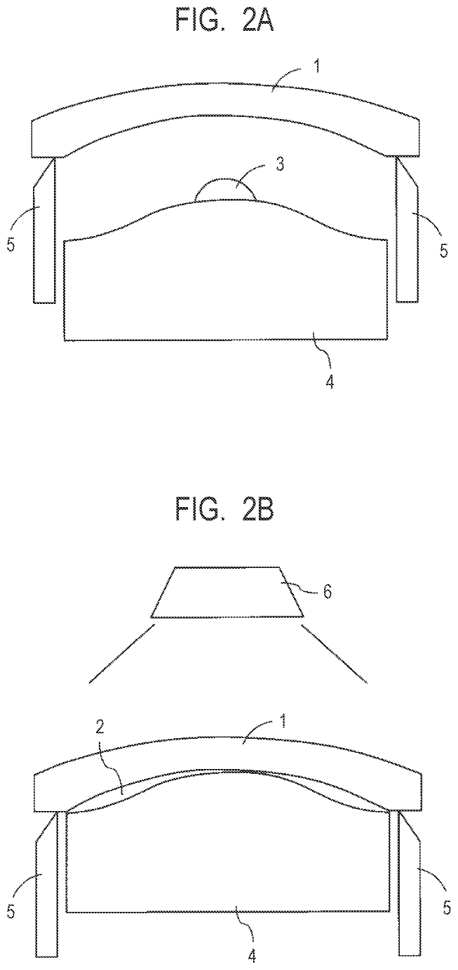

FIG. 1 is a schematic sectional view in the thickness direction showing the configuration of one embodiment of the optical element of the present disclosure, and FIGS. 2A and 2B are schematic sectional views in the thickness direction showing a step of molding the resin layer 2 of the optical element of FIG. 1.

As shown in FIG. 1, in the optical element of the present disclosure, the resin layer 2 is closely adhere to the substrate 1. The film thickness of the resin layer 2 is not uniform in the element radial direction and has a film thickness distribution in the plane. Thus, the surface of the resin layer 2 is provided with an aspherical shape. The film thickness distribution of the resin layer 2 is not particularly limited. The film thickness may be thin and minimum at the central portion and maximum at the peripheral portion. The film thickness may be thick and maximum at the central portion and thin at the peripheral portion. When the film thickness of the portion where the film thickness of the resin layer 2 is minimum (minimum film thickness) is d1 and the film thickness of the portion where the film thickness is maximum (maximum film thickness) is d2, it is preferable that d1 and d2 are in the range d1≤300 μm, 10 μm≤d2≤1000 μm and that the film thickness ratio is in the range 1<d2/d1≤30. It is not preferable for the film thickness ratio (d2/d1) to be larger than 30. When the difference in film thickness in the resin layer 2 is large in the plane, the difference in curing shrinkage amount at the time of forming the resin layer 2 also becomes large, which makes it difficult to maintain the plane accuracy.

(Substrate)

As the substrate 1 of the optical element, transparent resin or transparent glass can be used, and glass is particularly preferably used. As the glass, for example, general optical glass such as silicate glass, borosilicate glass and phosphate glass, and glass ceramics can be used.

The shape of the substrate 1 is not particularly limited, and the shape of the surface of the substrate in contact with the resin layer 2 can be selected from concave spherical, convex spherical, axisymmetric aspherical, plane, and the like. Further, in order to improve assembling accuracy when the optical element of the present disclosure is used in an optical system having a plurality of lenses, the outer shape of the substrate 1 is preferably circular.

(Resin Layer)

The resin layer 2 is closely adhere to the substrate 1 and the surface of the resin layer 2 has an aspherical shape. As shown in FIG. 2A, the aspherical shape of the resin layer 2 is formed by dropping an uncured polymerizable composition 3, which is a precursor of the resin layer 2, onto the metal mold 4, spreading it, and polymerizing and curing it. The polymerizable composition 3 is preferably an energy curable composition suitable for forming using a mold. The energy curable composition is a composition containing a component which is polymerized and cured from an uncured state to form a resin. by giving either or both of light energy and heat energy.

A polymerizable composition 3 to be used to form the resin layer 2 comprises a fluorene compound and at least one of a thiol compound and an oligomer of the thiol compound. The fluorene compound is represented by formula (1), comprising a fluorene skeleton and a polymerizable functional group. The thiol compound is represented by formula (2).

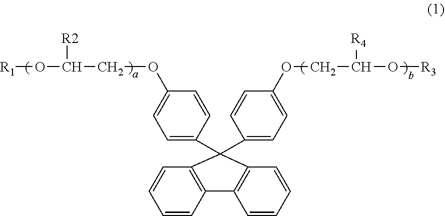

In above formula (1), R₁ and R₃ are each independently a polymerizable functional group represented by any one of formulas (a) to (e), R₂ and R₄ are each independently a hydrogen atom or a methyl group, and a and b are each independently an integer of 1 to 4.

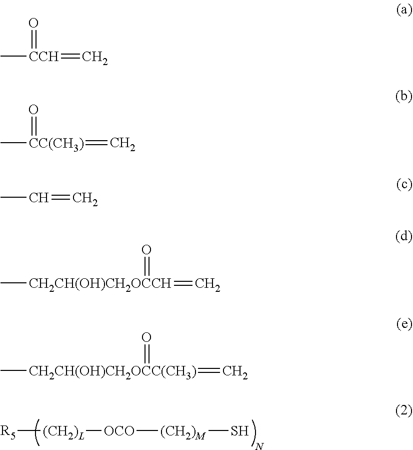

In above formula (2), R₅ is an N-valent hydrocarbon having 1 to 3 carbon atoms, L is an integer of 0 to 2, M is an integer of 1 or 2, and N is an integer of 2 to 4.

The fluorene skeleton of the fluorene compound has an effect of increasing a refractive index, an effect of reducing curing shrinkage caused by a bulky structure, an effect of reducing water absorption expansion caused by a rigid structure, and the like. The fluorene compound used in the present disclosure is preferably 9,9-bis [4-(2-acryloyloxyethoxy) phenyl] fluorene, wherein R₁ and R₃ are acryloyl groups, R₂ and R₄ are hydrogen atoms, and a and b are 1 in formula (1). By using the fluorene compound, the refractive index of the resin layer 2 can be further improved, and the curing rate of the polymerizable composition by ultraviolet irradiation can be increased. In the present disclosure, the fluorene compound (monomer) or an oligomer or polymer of the fluorene compound may be used. They may be used in combination. Preferable examples include Ogsole series EA-0200, EA-0500, EA-1000, EA-F5003, EA-F5503 all manufactured by Osaka Gas Chemical Co., Ltd, and the like. The fluorene compound may be used in one type or in combination of two or more types according to the curability of the resin layer 2 at the time of forming and the refractive index characteristics of the resin layer 2.

The thiol group of thiol compound represented by formula (2) and the ethylenically unsaturated group contained in the polymerizable functional group of the fluorene compound represented by formula (1) in the polymerizable composition 3 of the present disclosure are bonded by an enthiol reaction. The polymer obtained by an enthiol reaction is given flexibility by sulfur atoms incorporated into the structure, and the curing shrinkage rate of the polymer is reduced. Thus, when the resin layer 2 is formed using a mold, the transferability of the mold shape can be improved.

The number of functional groups (N in formula (2)) of the thiol compound used in the present disclosure is 2 to 4. Examples include ethylene bis (thioglycolate), 1,4-butanediol bis (thioglycolate), ethylene glycol bis (3-mercaptopropionate), trimethylolpropane tris (3-mercaptopropionate), pentaerythritol tetrakis (3-mercaptopropionate), and the like. Among them, bifunctional or trifunctional thiol compounds such as 1,4-butanediol bis (thioglycolate) and trimethylolpropane tris (3-mercaptopropionate) are preferably used. An oligomer of the above thiol compound or the combination of the thiol compound and the oligomer may be used for the polymerizable composition 3 used for forming the resin layer 2. Two or more different thiol compounds or oligomers thereof may be used in combination.

The content of the thiol compound is preferably prepared so that the ratio of the number of sulfur atoms contained in the thiol compound to the number of polymerizable functional groups of the fluorene compound contained in the polymerizable composition 3 is 0.02 or more and 0.25 or less. The number of polymerizable functional groups and the number of sulfur atoms are the total number in the polymerizable composition 3. When the ratio of the number of sulfur atoms is less than 0.02, a part of the resin layer 2 is peeled off from the mold when the resin layer 2 is irradiated with ultraviolet rays and cured, and the shape of the mold cannot be transferred. When the ratio of the number of sulfur atoms is more than 0.25, the water absorption expansion rate of the resin layer 2 becomes large, and the surface shape of the optical element is greatly deformed when the humidity in the operating environment changes, so that the optical performance of the optical element is fluctuated.

The ratio of the number of sulfur atoms can be calculated from the added amount of the thiol compound. If the amount of the thiol compound added is not known, it is also possible to peel the substrate 1 from the optical element, take out the resin layer 2, and evaluate the ratio. In this case, the quantitative composition analysis of the resin layer 2 is performed by performing NMR measurement and pyrolysis GCMS measurement on the resin layer 2 taken out. From the obtained composition analysis result, the number of polymerizable functional groups and the number of sulfur atoms contained in the resin layer 2 may be calculated, and the ratio of the number of sulfur atoms to the number of polymerizable functional groups may be calculated.

The polymerizable composition 3 of the present disclosure may contain a polymerization initiator. The polymerization initiator may be a photopolymerization initiator or a thermopolymerizable initiator and may be determined depending on the production method selected. However, in the case of carrying out replica forming for producing an aspherical shape, it is preferable to contain a photopolymerization initiator from the viewpoint of improving the curing speed. Photopolymerization initiators include, for example, 2-benzyl-2 dimethylamino-1-(4-morpholinophenyl)-1-butanone, 1-hydroxy-cyclohexyl-phenyl-ketone, bis (2,4,6-trimethylbenzoyl)-phenylphosphine oxide, 4-phenylbenzophenone, 4-phenoxybenzophenone, 4,4′-diphenylbenzophenone, 4,4′-diphenoxybenzophenone. The content of the photopolymerization initiator is preferably in the range of 0.01 mass % or more and 10 mass % or less in the polymerizable composition 3. When the content of the photopolymerization initiator is less than 0.01 mass %, sufficient reactivity cannot be obtained, and when the content exceeds 10 mass %, the transmittance of the resin layer 2 decreases, which may cause a disadvantage in the performance of the device.

To the polymerizable composition 3 of the present disclosure, a polymerization inhibitor, an antioxidant, a light stabilizer (HALS), an ultraviolet absorber, a silane coupling agent, a release agent, a pigment, a dye, or the like can be added as necessary.

When the water absorption and expansion rate of the resin layer 2 is 0.2 mass % or less, the effect of suppressing deterioration in optical performance when the humidity in the operating environment changes becomes more remarkable. The water absorption expansion rate represents the expansion rate of the resin when the environment is changed from a temperature of 40° C. and a humidity of 0% to a temperature of 40° C. and a humidity of 90%. The resin layer 2 preferably has a d-line refractive index of 1.55 or more to 1.65 or less, and an Abbe number vd of 25 or more to 35 or less. A detailed measurement method will be described later.

(Method of Producing Optical Element)

The method for manufacturing the optical element of the present disclosure is not particularly limited, but preferably, the polymerizable composition of the present disclosure is hold between a substrate and a metal mold and the polymerizable composition is polymerized and cured to form a resin layer on the substrate. Referring to FIGS. 2A and 2B, an example of a manufacturing process of an optical element in which a resin layer is molded using an ultraviolet-curable polymerizable composition will be described.

In order to improve the adhesiveness between the substrate 1 to the resin layer 2, it is preferable that the surface of the substrate 1 which adheres to the resin layer 2 is pretreated. When the substrate 1 is glass, a silane coupling treatment, a corona discharge treatment, a UV ozone treatment, a plasma treatment or the like can be appropriately selected as the surface pretreatment in order to enhance adhesiveness with the resin layer 2. In the present disclosure, since the adhesiveness can be particularly enhanced by direct chemical bonding with the resin layer 2, it is preferable to carry out a coupling treatment using a silane coupling agent. Specific coupling agents include hexamethyldisilazane, methyltrimethoxysilane, trimethylchlorosilane, triethylchlorosilane and the like.

Next, the resin layer 2 is formed. First, as shown in FIG. 2A, an uncured ultraviolet curable polymerizable composition 3 which is a precursor of the resin layer 2 is dropped onto the metal mold 4. The substrate 1 is placed on the ejector 5 so as to face the metal mold 4. The metal mold 4 used here has a shape that is an inversion of the desired aspherical shape on the surface, and can be produced by cutting metal base materials such as stainless steel and steel with such as NiP plating and oxygen free copper plating by using a precision machine. A release agent may be applied to the surface of the metal mold 4 to control the release property of the resin. The type of the release agent is not particularly limited, and a fluorine coating agent or the like can be exemplified.

Next, as shown in FIG. 2B, after the ejector 5 is lowered to fill the uncured polymerizable composition 3 between the metal mold 4 and the substrate 1, the resin layer 2 which is a polymerized cured product of the polymerizable composition 3 is obtained by irradiating ultraviolet rays from the substrate 1 side with an ultraviolet light source 6.

Thereafter, the polymerized and cured resin layer 2 is released from the metal mold 4 to obtain an optical element having a resin layer 2 with an aspherical shape on the substrate 1. After the resin layer 2 is formed, additional irradiation with ultraviolet rays or heat treatment may be performed in the atmosphere or in an oxygen free atmosphere.

The optical element of the present disclosure can be prepared by the above producing method.

(Optical Device)

Specific application examples of the optical element of the present disclosure include lenses constituting optical device (photographing optical system) for cameras and video cameras, lenses constituting optical device (projecting optical system) for liquid crystal projectors, and the like. The optical element of the present disclosure can also be used as a pickup lens for a DVD recorder or the like. These optical systems may comprise a plurality of lenses arranged in a housing, and at least one of the plurality of lenses may be an optical element of the present disclosure.

(Image Capturing Apparatus)

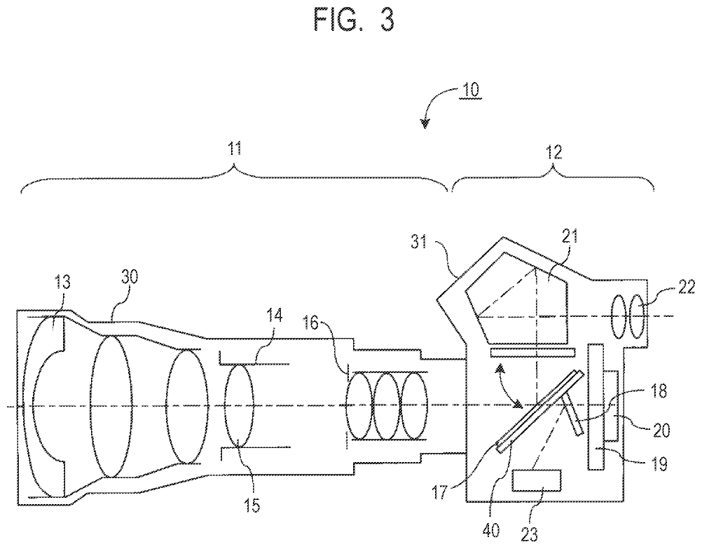

FIG. 3 is a schematic diagram showing a configuration of a single-lens reflex digital camera 10, which is an example of a preferred embodiment of an image capturing apparatus using an optical element of the present disclosure. In FIG. 3, a camera body 12 and a lens barrel 11, which is an optical device, are bonded to each other, while the lens barrel 11 is a so-called interchangeable lens detachable from the camera body 12.

Light from an object is photographed through an optical system comprising a plurality of lenses 13, 15, etc., arranged on an optical axis of the photographing optical system in the housing 30 of the lens barrel 11. The optical element of the present disclosure can be used as the lenses 13 and 15, for example. Here, the lens 15 is supported by an inner cylinder 14 and movably supported to an outer cylinder of the lens barrel 11 for focusing or zooming.

During an observation period before shooting, light from a photographic subject is reflected from a main mirror 17 in the housing 31 of the camera body and passes through a prism 21, thereby displaying a shooting image to a photographer through a finder lens 22. The main mirror 17 is, for example, a half mirror. Light passing through the main mirror is reflected from a sub-mirror 18 toward an autofocus (AF) unit 23, and for example, the reflected light is used for distance measurement. The main mirror 17 is mounted and supported on a main mirror holder 40 by bonding or the like. At the time of photographing, the main mirror 17 and the sub-mirror 18 are moved out of an optical path by means of a drive mechanism which is not illustrated. A shutter 19 is opened to form a photographing light image so that an image capturing element 20 receives light incident from a lens barrel 11 and passing through the photographing optical system. A diaphragm 16 is configured to change the brightness and the depth of focus during photographing by changing the opening area.

Although the image capturing apparatus has been described here with a single-lens reflex digital camera, the optical element of the present disclosure can also be used in a smartphone or a compact digital camera and the like.

### EXAMPLES

Hereinafter, the present disclosure will be more specifically described with reference to examples and comparative examples. First, the evaluation method of the examples and the comparative examples will be described.

(Evaluation Method)

<D-Line Refractive Index nd and Abbe Number vd>

The refractive index and Abbe number vd of the resin layer of the optical element were evaluated by preparing a sample for optical characteristic evaluation. Instead of using the sample for optical characteristic evaluation, the evaluation is also possible using a resin obtained by scraping a base material from an optical element. First, a method of preparing a sample for optical characteristic evaluation will be described.

A spacer having thickness of 500 μm and an uncured polymerizable composition which is the material for a resin layer to be measured were arranged on a glass (S-TIH) having a thickness of 1 mm. A quartz glass having a thickness of 1 mm was placed on the polymerizable composition via the spacer to press and spread the uncured polymerizable composition. Next, the spacer was removed, and light was irradiated from above the quartz glass with a high-pressure mercury lamp (UL750, manufactured by HOYA CANDEO OPTRONICS) at 20 mW/cm² (=illuminance through quartz glass) for 2500 seconds (50 J). The polymerizable composition was cured, the quartz glass was peeled off, and then the obtained product was annealed at 80° C. for 16 hours to prepare a sample for optical characteristic evaluation. The shape of the cured resin layer was 500 μm in thickness and 5 mm×20 mm in size in the glass surface.

The refractive indices (nf, nd, nc) of the respective wavelengths of the f-line (486.1 nm), the d-line (587.6 nm), and the c-line (656.3 nm) were measured from the glass side of the obtained sample by using a refractometer (KPR-30 manufactured by Shimadzu Corporation).

The Abbe number νd was calculated from the measured refractive index of each wavelength. The Abbe number νd was calculated by the following equation.

Abbe number νd=(nd−1)/(nf−nc)

<Water Absorption Expansion Rate>

The water absorption expansion rate of the resin layer of the optical element was evaluated by preparing a sample for measuring the water absorption expansion rate.

Instead of using the sample for measuring the water absorption expansion rate, the evaluation is also possible using a resin obtained by scraping a base material from an optical element. First, a method of preparing a sample for measuring the water absorption expansion rate will be described.

Both sides of a glass (BK-7) having a thickness of 1 mm were coated with DURASURF (manufactured by Havez Co., Ltd.), and a spacer having thickness of 200 μm and an uncured polymerizable composition which is the material for a resin layer to be measured were arranged thereon. A glass (BK-7) having a thickness of 1 mm was placed on the polymerizable composition via the spacer so as to press and spread the uncured polymerizable composition. Next, the spacer was removed, and light was irradiated from above the glass (BK-7) with a high-pressure mercury lamp (UL750, manufactured by HOYA CANDEO OPTRONICS) at 20 mW/cm² (=illuminance through glass) for 2500 seconds (50 J). The polymerizable composition was cured, the glasses (BK-7) on both sides were peeled off, and then annealed at 80° C. for 16 hours to prepare a sample for measuring the water absorption expansion rate. The shape of the cured resin layer was 200 μm in thickness and 20 mm×5 mm in length and width.

The water absorption expansion rate was measured with a HUM-TMA device (manufactured by Rigaku Corporation) using the obtained sample. The sample for evaluation was set in the apparatus, and after moisture was released at a temperature of 80° C. and a humidity of 0% for 3 hours, a displacement t0 when the temperature was set at 40° C. and a humidity of 0% was measured, and then a displacement t1 when the humidity was increased to 90% while the temperature was kept at 40° C. was measured. Using these measured values and the length T of the sample for evaluation, the water absorption expansion rate [%] was calculated using the following equation.

Water absorption expansion rate [%]=((t1−t0)/T)×100

<Evaluation of Peeling of Resin Layer>

When the polymerizable composition 3 is filled between the metal mold 4 and the substrate 1 as shown in FIG. 2A and cured by irradiation with ultraviolet rays as shown in FIG. 2B, the shape of the metal mold 4 cannot be transferred and a part of the resin layer 2 may be peeled off from the metal mold 4 or the resin layer 2 itself may be broken. This is caused by the fact that when the polymerizable composition 3 is cured on the metal mold 4 to form the resin layer 2, the curing shrinkage amount of the resin layer 2 is different in the plane depending on the in-plane film thickness distribution. That is, during polymerization and curing of the polymerizable composition 3, stress is accumulated at the resin/mold interface in a portion where the film thickness of the resin layer 2 is thick, and the peeling and cracking are generated.

The resin 2 at the time of curing was visually observed over the substrate 1, and the resin with no peeling or cracking was evaluated as “A”, and the resin with peeling or cracking was evaluated as “B”.

<Surface Shape of Optical Element>

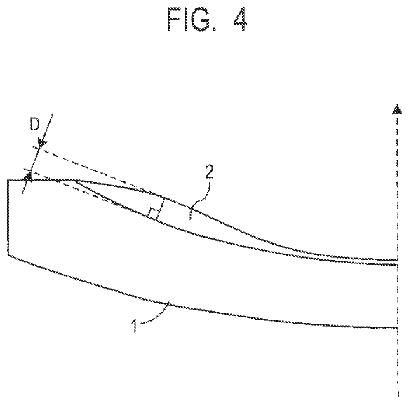

The optical element prepared by the producing method illustrated in FIGS. 2A and 2B was placed in an oven at 80° C. for 16 hours. The surface shape of the resin layer 2 was measured 20 minutes after taking out the resin layer 2 out of the oven to a room temperature environment (23° C.±2° C.) using a form-talysurf (TAYLORHOBSON). The measurement was carried out in a straight line from the optical element end to the opposite end through the center, and the scanning speed was set at 0.5 mm/sec. The vertical distance from the interface between the substrate 1 and the resin layer 2 to the measured surface shape of the resin layer 2 was calculated to obtain the film thickness D of the resin layer 2. The film thickness D is shown in FIG. 4. The average value of the obtained film thickness in the radial direction was set to D0, the minimum value of the film thickness was set to d1, and the maximum value was set to d2.

The optical element was then placed in a constant temperature and humidity furnace at a temperature of 40° C. and a humidity of 90% for 16 hours. The surface shape of the resin layer 2 was measured using the form-talysurf 20 minutes after taking the optical element out of the oven to a room temperature environment (23° C.±2° C.). The average value of the film thickness was calculated in the same manner as described above, and the obtained film thickness was set to D1. From the thus obtained average film thickness value D0 before water absorption and average film thickness value D1 after water absorption, the element expansion rate [%] of the optical element was calculated using the following equation.

Element expansion rate [%]=((D1−D0)/D0)×100

<Overall Evaluation>

“A” in overall evaluation means that the evaluation of peeling of resin layer was “A”, and the element expansion rate in the surface shape of the optical element was less than 0.4%.

“B” in overall evaluation means that the evaluation of peeling of resin layer was “B”, or the element expansion rate in the surface shape of the optical element was 0.4% or more.

When the expansion rate of the optical element was 0.4% or more, the optical performance of the optical element changed under the change of humidity in the operating environment, and the image quality when the optical element was used for the optical system was greatly deteriorated.

### Example 1

First, a polymerizable composition for the example was prepared. 48 parts by mass of 9, 9-bis [4-(2-acryloyloxyethoxy) phenyl] fluorene as a fluorene compound, 35 parts by mass of pentaerythritol triacrylate as a (meth) acrylic compound, 15 parts by mass of urethane-modified polyester acrylate and 2 parts by mass of 1-hydroxycyclohexyl phenyl ketone were put into a bottle and uniformly mixed. Further, 1 parts by mass of 1, 4-butanediol bis (thioglycolate) as the thiol compound was added to 100 parts by weight. of the mixture, and the obtained mixture was uniformly mixed to be a polymerizable composition.

Next, the optical element was prepared by the producing method illustrated in FIGS. 2A and 2B. An optical glass having a diameter of 32 mm (manufactured by OHARA Corporation, glass type: S-TIM8) was used as the substrate. One side of the substrate had a concave spherical surface shape of R40 mm and the other side of the substrate had a convex spherical surface shape with R75 mm. The metal mold used was formed by cutting an NiP layer which was plated on a metal base material with a precision machine to form a shape that is an inversion of the aspherical shape of the resin layer to be formed.

The prepared uncured polymerizable composition was filled between the metal mold and the substrate. Thereafter, the polymerizable composition was irradiated with ultraviolet light having an intensity of 10 mW/cm² at a wavelength of 365 nm for 200 seconds to be cured. After the metal mold was released, a resin layer was formed on the substrate by heating at 80° C. for 24 hours to obtain the optical element of Example 1.

The resin layer of the optical element of Example 1 had the refractive index nd of the d-line of 1.59 and the Abbe number νd of 30. The resin layer of the optical element of Example 1 had an uneven shape, was thin in the center, had a minimum value of the film thickness at the center and had a maximum value of the film thickness at the periphery. The film thickness d1 at the portion where the film thickness was minimum (center) and the film thickness d2 at the portion where the film thickness (periphery) was maximum were d1=50 μm and d2=400 μm respectively.

### Example 2

An optical element was prepared in the same manner as in Example 1 except that 2 parts by mass of 1,4-butanediol bis (thioglycolate) was used as the thiol compound in preparing the polymerizable composition.

The resin layer of the optical element of Example 2 had the film thickness d1 at the portion where the film thickness was minimum (center) and the film thickness d2 at the portion where the film thickness (periphery) was maximum of d1=30 μm and d2=380 μm respectively.

### Example 3

An optical element was prepared in the same manner as in Example 1 except that 10 parts by mass of 1,4-butanediol bis (thioglycolate) was used as the thiol compound in preparing the polymerizable composition. The uneven shape of the resin layer of the optical element of Example 3 was the same as that of Example 1.

### Example 4

An optical element was prepared in the same manner as in Example 1 except that 3 parts by mass of trimethylol propane tris (3-mercapto propionate) was used as the thiol compound in preparing the polymerizable composition. The uneven shape of the resin layer of the optical element of Example 4 was the same as that of Example 1.

### Comparative Example 1

An optical element was prepared in the same manner as in Example 1 except that no thiol compound was added to the polymerizable composition. The uneven shape of the resin layer of the optical element of Comparative Example 1 was the same as that of Example 1.

### Comparative Example 2

An optical element was prepared in the same manner as in Example 1 except that 15 parts by mass of 1,4-butanediol bis (thioglycolate) was used as the thiol compound in preparing the polymerizable composition. The resin layer of the optical element of comparative Example 2 had the film thickness d1 at the portion where the film thickness was minimum (center) and the film thickness d2 at the portion where the film thickness (periphery) was maximum of d1=30 μm and d2=380 μm respectively.

The evaluation results of the resin layer and the evaluation results of the optical element in Examples and Comparative Examples are described below.

TABLE 1

| | | | | | Comparative | Comparative |
|---|---|---|---|---|---|---|
| | Example 1 | Example 2 | Example 3 | Example 4 | Example 1 | Example 2 |
| Number of functional groups | Bifunctional | Bifunctional | Bifunctional | Trifunctional | None | Bifunctional |
| of thiol compound | | | | | | |
| Number of sulfur atoms/ | 0.02 | 0.04 | 0.21 | 0.06 | 0 | 0.31 |
| number of polymerizable | | | | | | |
| functional groups | | | | | | |
| Refractive index nd | 1.59 | 1.59 | 1.59 | 1.59 | 1.59 | 1.59 |
| Abbe number vd | 30 | 30 | 30 | 30 | 30 | 30 |
| Water absorption expansion | 0.07 | 0.08 | 0.13 | 0.09 | 0.07 | 0.22 |
| coefficient [%] | | | | | | |
| Film thickness d1 [μm] | 50 | 30 | 50 | 50 | 50 | 30 |
| Film thickness d2 μm] | 400 | 380 | 400 | 400 | 400 | 380 |
| d2/d1 | 8 | 12.7 | 8 | 8 | 8 | 12.7 |
| Peeling of resin layer at shaping | A | A | A | A | B | A |
| Element expansion coefficient [%] | 0.14 | 0.16 | 0.26 | 0.18 | 0.14 | 0.44 |
| Overall evaluation | A | A | A | A | B | B |

As shown in Table 1, in the optical element of Comparative Example 1, when the resin layer was cured on the metal mold, the resin layer peeled off from the mold surface and the shape of the mold could not be transferred. It is assumed that the peeling occurred because the curing shrinkage rate and elastic modulus rate of the polymerizable composition used for the optical element of Comparative Example 1 were large and the stress applied to the interface between the resin layer and the metal mold was large at the time of curing. In the optical element of Comparative Example 2, although peeling was not confirmed during forming, the amount of deformation of the surface shape of the optical element due to moisture absorption became large. The reasons for the above are presumed as follows. In the optical element of Comparative Example 2, the ratio of the number of sulfur atoms present in the strong network due to the acrylic bond in the resin layer was large, which caused the disturbance of the acrylic network, and furthermore, the flexibility was imparted by the sulfur atoms, so that the resin cured product was more easily deformable and the deformation at the time of moisture absorption became more remarkable.

On the other hand, in Examples 1 to 4 in which the ratio of the number of sulfur atoms to the number of polymerizable functional groups was 0.02 to 0.25, peeling did not occur during forming of the resin layer, and deformation of the surface shape of the optical element during moisture absorption was also small.

As described above, in the optical element of the present disclosure, since the change of the surface shape due to the water absorption expansion and the shrinkage of the resin layer was reduced, the optical performance is hardly varied when the humidity in the operating environment changes. Therefore, the performance of the optical apparatus and the image capturing apparatus using the above optical element can be improved.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-011604, filed Jan. 28, 2021, which is hereby incorporated by reference herein in its entirety.

What is claimed is:

1. An optical element comprising a substrate and a resin layer on said substrate, wherein the resin layer comprises a polymerization product of a polymerizable composition comprising:
a fluorene compound represented by formula (1); and
at least one of a thiol compound represented by formula (2) and an oligomer of the thiol compound: 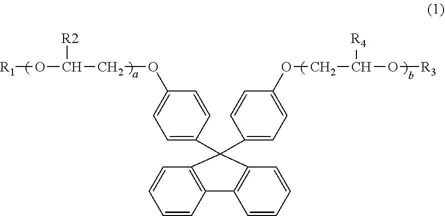
where R₁ and R₃ are each independently a polymerizable functional group represented by any one of formulas (a) to (e), R₂ and R₄ are each independently a hydrogen atom or a methyl group, and a and b are each independently an integer of 1 to 4, 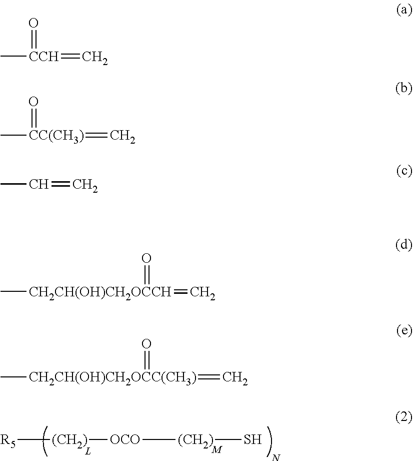
where R₅ is an N-valent hydrocarbon having 1 to 3 carbon atoms, L is an integer of 0 to 2, M is an integer of 1 or 2, and N is an integer of 2 to 4,
wherein
a ratio of the number of sulfur atoms in said at least one of a thiol compound and an oligomer of the thiol compound to the number of polymerizable functional groups in said fluorene compound is 0.02 or more and 0.25 or less.

2. The optical element according to claim 1,
wherein the resin layer has a minimum film thickness d1 and a maximum film thickness d2 which satisfy the following conditions:
d1≤300 μm;
10 μm≤d2≤1000 μm; and
1<d2/d1≤30.

3. The optical element according to claim 1, wherein the resin layer has a d-line refractive index of 1.55 or more to 1.65 or less.

4. The optical element according to claim 1, wherein Abbe number νd of the resin layer is 25 or more to 35 or less.

5. A polymerizable composition comprising:
a fluorene compound represented by formula (1); and
at least one of a thiol compound represented by formula (2) and an oligomer of the thiol compound: 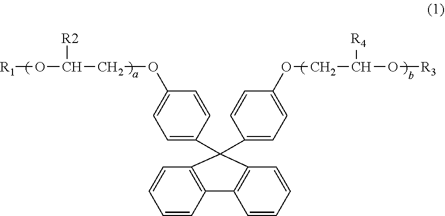
where R₁ and R₃ are each independently a polymerizable functional group represented by any one of formulas (a) to (e), R₂ and R₄ are each independently a hydrogen atom or a methyl group, and a and b are each independently an integer of 1 to 4, 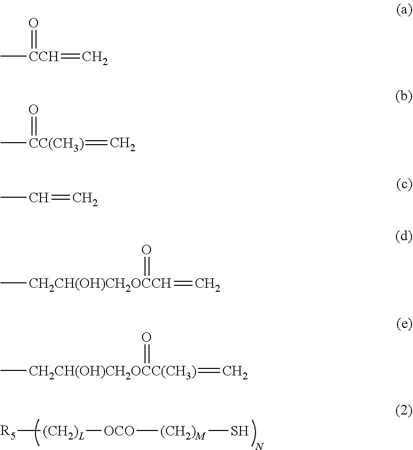
where R₅ is an N-valent hydrocarbon having 1 to 3 carbon atoms, L is an integer of 0 to 2, M is an integer of 1 or 2, and N is an integer of 2 to 4,
wherein
a ratio of the number of sulfur atoms in said at least one of a thiol compound and the oligomer of the thiol compound to the number of polymerizable functional groups in said fluorene compound is 0.02 or more and 0.25 or less.

6. A method of producing an optical element comprises:
holding the polymerizable composition according to claim 5 between a substrate and a mold; and
polymerizing and curing the polymerizable composition to form a resin layer on the substrate.

7. An optical device comprising a housing and an optical system having a plurality of lenses arranged in the housing, wherein at least one of the plurality of lenses is an optical element according to claim 1.

8. An image capturing apparatus comprising:
a housing;
an optical system having a plurality of lenses arranged in the housing; and
an image capturing element for receiving light passing through the optical system,
wherein at least one of the plurality of lenses is the optical element according to claim 1.

9. An image capturing apparatus according to claim 8, wherein said image capturing apparatus is a camera.
